(19) United States
(12) Patent Application Publication
(10) Pub. No.: US 2013/0124367 A1
(43) Pub. Date: May 16, 2013

(54) SYSTEM FOR DISTRIBUTING INDIVIDUALIZED AUDIO INFORMATION OVER A NETWORK

(71) Applicant: Stephen A. Ray, Nashville, TN (US)

(72) Inventor: Stephen A. Ray, Nashville, TN (US)

(21) Appl. No.: 13/466,931

(22) Filed: May 8, 2012

Related U.S. Application Data
(63) Continuation-in-part of application No. 13/234,981, filed on Sep. 16, 2011.
(60) Provisional application No. 61/383,765, filed on Sep. 17, 2010.

(51) Int. Cl. G06Q 30/06

(52) U.S. Cl. CPC G06Q 30/0625
USPC 705/26.62

(57) ABSTRACT

A system for providing individualized information to a consumer over a network has been developed. The system includes a device, such as a sign, that identifies to a consumer a subject of interest. The device provides a unique identifier associated with the subject that allows the consumer to access individualized information about the subject of interest through a website. The consumer sends the identifier to the system with a mobile communications device and receives the information about the subject in the form of an audio file.

### CROSS-REFERENCE TO RELATED APPLICATIONS

This application is a continuation-in-part of U.S. patent application Ser. No. 13/234,981 that was filed on Sep. 16, 2011, which claims priority from U.S. Provisional Patent Application No. 61/383,765 that was filed Sep. 17, 2010.

### FIELD OF THE INVENTION

The invention relates generally to system of distributing personalized information in an audio format over a network.

### SUMMARY OF THE INVENTION

In some aspects, the invention relates to a system for providing individualized information to a consumer over a network, comprising: a notification apparatus that identifies a subject associated with individualized information to a consumer, where the notification apparatus also provides a unique identifier associated with the subject of the individualized information; a system server that stores the individualized information from a provider of the information; and an internet website that allows the consumer to access the individualized information upon receipt of a unique identifier associated with the subject of the individualized information, wherein the consumer sends the unique identifier to the system server through a mobile telecommunications device.

In other aspects, the invention relates to a system for providing individualized information to a consumer over a network, comprising: a notification apparatus that identifies a subject associated with individualized information to a consumer, where the notification apparatus determines the consumer's location through a GPS capability on a mobile telecommunications device belonging to the consumer; where the system sends a message alerting the consumer that presence of the notification apparatus; a system server that stores the individualized information from a provider of the information; and an internet website that allows the consumer to access the individualized information upon receipt of a the message.

In other aspects, the invention relates to a system for providing individualized information to a consumer over a network, comprising: means for a identifying a subject associated with individualized information to a consumer and providing a unique identifier associated with the subject of the individualized information; means for storing the individualized information from a provider in an electronically accessible media; and means for allowing the consumer to access the individualized information upon receipt of a unique identifier through a mobile telecommunications device.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a diagram of one embodiment of the present invention.

FIG. 2 shows diagram of the relationships of elements of the system in one embodiment of the present invention.

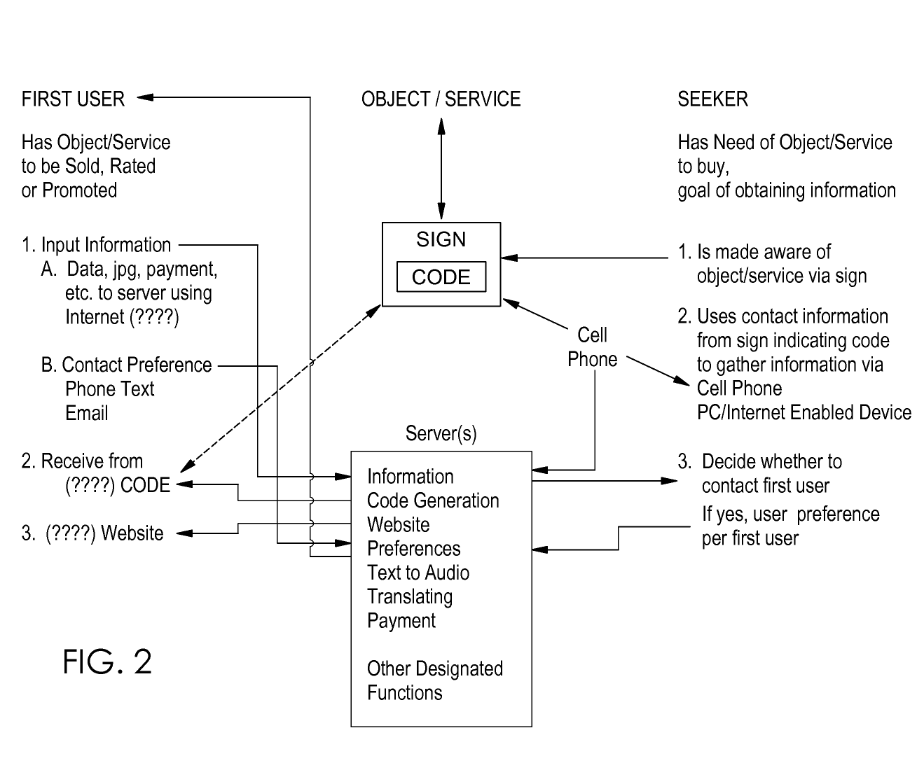

FIG. 3 shows an example of a sign used in one embodiment of the present invention.

### DETAILED DESCRIPTION

This application claims priority from U.S. Provisional Patent Application No. 61/383,765 and its contents are hereby incorporated by reference.

A system for distributing individualized audio files over a network has been developed. The system serves to link providers of information with consumers of information. These may also be known as sellers and buyers, givers and seekers, etc, depending on the context. The purpose of this system is to allow for the initial conveyance of information to be done using a simple cell phone or, and to further permit the use of more advanced devices such as smart phones, tablets, computers, etc.

The information being transferred typically revolves around a specific article or subject being promoted, whether a property, a vehicle, a service, or in the context of a social network, a particular person. The type and level of access to information that a provider permits the consumer to obtain may also vary. Providers may or may not permit direct phone contact, text message contact or email contact. They may or may not provide a physical point of contact: for a house or car (e.g. 123 Main Street) or a virtual contact such as a web address.

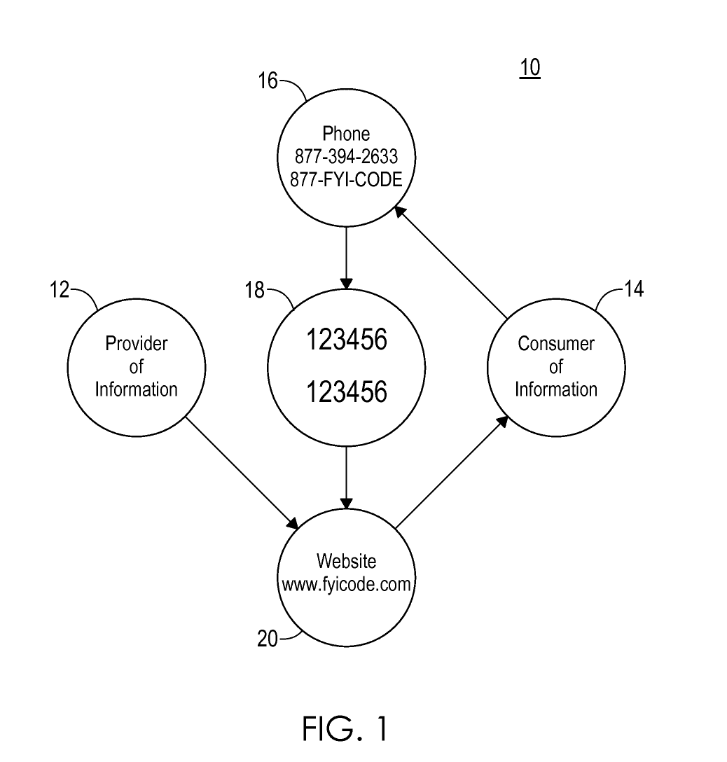

FIG. 1 shows a diagram of one embodiment of the present invention. In this example, the consumer 14 sees a form of notice indicating that information about the subject is available. For example, the notice may be a yard sign such as for a home for sale. The sign will provide a phone number for the consumer to call 16. Also, the sign will provide a unique identifying number 18 for the subject. Once connected to the system 10, the consumer will enter the identifying number 18 and unique information concerning the subject will be sent from the system's website 20 to the consumer 14 either as an audio file or text message link or audio file followed by the option of a text message link. The unique information will have been previously loaded on the system's website 20 by the provider of information 12.

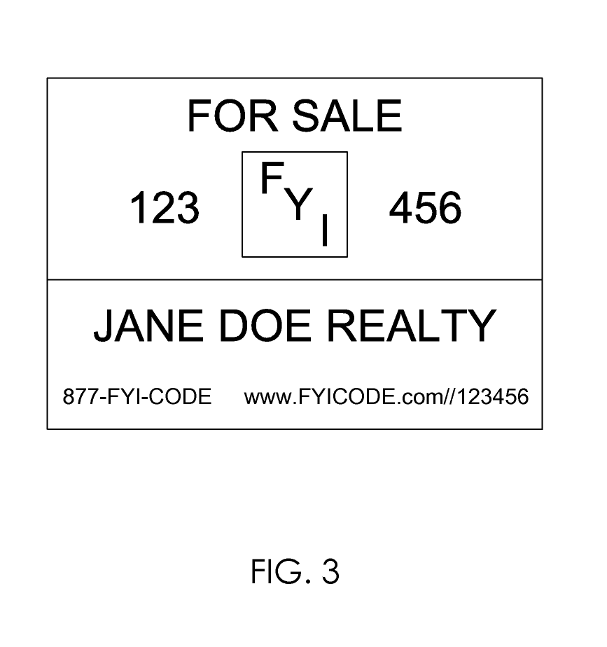

In alternative embodiments, notice and subject could vary widely. For example, the system could use a sign to provide notice of a garage sale. Also, it may use a billboard promoting a website or a soft drink. It may use a T-shirt promoting a person, a cause, or support for a team. It could be a bumper sticker, a car decal or printed in a magazine. FIG. 3 shows an example of a sign in one embodiment of the present invention.

It is envisioned that each person or business could have a unique number, that when used with this system would allow anyone to connect with the person or entity with that number anywhere in the world. A phone number based point of contact and a website base for the “code” number itself are the two major components that make this system both useful and operational. In the present system, for ease of memory retention, the unique identifying number uses only 6 digits for ease of memory retention. This is important because this system's main use will be from the comfort of an automobile. Note also the positioning of the digits in two groups of three separated by a space, making the digits easier to retain on the part of mobile viewer.

In the broader context though, this is the convergence of a business or person's telephonic identity, and, that of their web identity. This system, while not limited to any number, could easily use a twelve (or more) digit matrix to expand the number of users whether people or businesses. The present invention may have use not only in a business context but for social interaction as well. The core of the system is the unique identifying “code” number. Once an entity has a “code” number and others know what to do with it, information may flow between givers and those who seek it.

It should be understood that that the invention can be used in a social media context. Thus, if you were at a party, you could give someone your code number (perhaps on a card or worn on your nametag or garment of some sort) and others could call the code and find out certain information that you had predetermined to disclose. It is understood that an “app” could be used for retrieving this same information whether via a cell phone or other electronic device, such as a computer, reader of any sort, tablet, etc. In other embodiments, the code number could be retrieved by using an optical or electronic scanner.

The disclosure of information would be completely controlled by the owner of the number and would not require any action or pre-approval by the provider to create a social relationship. Examples of information from the provider include name or title. This could be the name of a person, object (car, house, boat,), type of service (sale, yard sale, for rent, open house, detour), place (such as an address), business (for profit, non profit,) institution (hospital, school or university) or intellectual subject such as a book, a piece of music or other performance, or a link to a website. The information may also include a contact name or title of person or entity that “owns” the particular number. Alternatively, the number could be a person or entity associated with the subject. For example, a car dealer might put out information on a vehicle and a consumer using a phone call to inquire about the vehicle will connect with a specific person about the vehicle or the next available representative. Additional examples of information from the provider include: a text message, a video file, pictures other audio files and all of the links thereto.

The information is stored on a system server and accessed by the consumer through the website once the unique identifying number is verified. The information is loaded onto the system's server when the provider initiates the use of the system. In some embodiments, the use of the system is on a subscription basis (typically for repeat providers with multiple listings, e.g. real estate agent with multiple listings) or on a fee basis (typically for one time users, e.g., an individual having a yard sale). Once the service is activated and the number is assigned, the provider will provide the information to be sent to the consumer upon request.

In another embodiment, the information from the provider will be in the form of an audio file. Additionally, the system may use voice activation for the entry of the unique number. This facilitates the easy use of the system by someone who is driving car, sees a sign of interest, and then dials the number and enters the unique identifying number. The information is the relayed to the consumer in the form of an audio message while they are still driving in their car. The audio file may be self recorded by the provider or may be automatically generated by the system. The information may also include the option of being “call forwarded” to a live person. The information may initiate a connection to the website of the provider either through the intermediary site of the system or directly via the provision of a text message link to caller generated by the provider through the system. Additionally, the system will have the capability for multilingual calls.

In further embodiments, the unique identifying “code” of a provider may include numerals, letters, symbols or a combination of alphanumeric digits. Additionally, the unique identifier may be a textual or a spoken word or combination of words, name, or even a sound such as music or tones such as DTMF (Dual Tone Multi Frequency) signals to act as the activation code to access the provider's information. As an example of this embodiment, someone may hear a radio advertisement while driving and use a spoken word to access the system instead of a numeric code. In such an instance, a word, phrase, slogan, etc. may be easier for a user to remember than a series of numbers.

Another embodiment could utilize a GPS (Global Positioning System) capability to further facilitate use of the system. With the GPS capability, the system would recognize not only a user's cell number but their location. Instead of having to say a specific store's location, the user could just say he store name by itself. The system will then use the GPS data to bring up to the code for the nearest store of that brand (e.g., ACME Groceries on 1^{st} Avenue). As an alternative, the user could say a category of store such as “pharmacy” or “coffee shop” and the system would bring up the code for the nearest location without reference to a specific brand. This could be used with standard cell phones, “smart phones” or other similar telephony/internet capable device with a loaded system application.

A system application or “app” can be a specific application that accesses the system and is loaded on a Smartphone. It is intended for the app to utilize open APIs (application programming interfaces) for developers to write their own apps. The app, when turned on, will be in connection with the system, so that when user goes by a business or fixed object that has a system identification code, the system will know this through GPS capability. The app may ask the user if they want to hear the recording for a business with a code when within a specified distance of that business. If the user replies yes, they will hear the recording for that identifying code (or receive a text link) without doing anything else. In this embodiment (known as “pushing”) there is no number to call and nothing to say or identifying code to enter. The user only has to give permission to the app to connect. The system could be easily set to allow the information to be triggered before the viewer was even in site of the property. In essence, the system may now be “broadcast”. The GPS location merely connects the user to a particular website associated with that coordinate.

When both users and providers register to use the system, they can use indicate a preferences and capabilities for products or services. These selections can be used to filter the results (restaurants, malls, movies, banks, lost pets, lost persons etc.). There can be multiple categories for use. For example, a food provider might check off the categories “restaurant, take out, gluten free, home delivery, etc.” They put in their address and then select a “radius of delivery service”. The user may simply use the “app” and changes the setting from “home hunting” to “restaurants”. Many refinements can be envisioned for allowing the consumer to set preferences that would filter results. Users will also be able to set “favorites” brands in a similar manner as they will be able to set number of bedrooms and bathrooms in a house search.

For billboards, the concept is the same, except that the system portal may be associated with multiple coordinates. As a user drives along the highway, a billboard will be able to entice the user with a menu item appropriate for that time of day, such as breakfast, lunch or dinner.

The user may turn the app off if they don't want it asking you whether it should access codes for nearby businesses and the like. Instead, the user may have the option not hearing the provider's recording but getting the text link only and/or getting an email sent regarding the business or property. In this example, when the user calls in a code, or responds to the app with yes, the user receives an email that has that link. This allows the user to skip the recording and/or review everything later at home, especially useful if looking at a lot of properties like houses, in a hurry, or just want to avoid reviewing while driving.

An additional app may include a specialized application for providers. This app will allow providers to administratively manage their system account. For example, the provider would be able to: use text to speech updates for their recording; change the recording via a new wave (.wav) file or a direct recording to the system; allow changes between distributing a recording, text link, or email to the user; and control any billing or other administrative features of their account. This app may provide access for the provider from any web portal, not just a mobile device.

A key distinction in some embodiments of the invention is that the system brings up a recording first to the user and then presents the option to go to a provider's website. Other embodiments may allow a user to access the system by coming in through a text link which was forwarded to them by the system. The text link that takes them to the provider's webpage, where the user could then listen to the recording.

For providers with items that are not fixed locations or movable, like political signage or delivery trucks, there could be a transmitter of a signal to the app when the user is within a specified distance. For example, if the user is following a floral delivery truck with a code displayed on its rear, the app could ask the user if they want to access the code for that florist.

Another potential embodiment uses a toll free or regular number that is NOT the standard system number to access a recording. With a toll free number specifically for one code, a user calls that number and it goes directly into the recording for that “code”. Once the system answers, it goes directly into the recording without the user having to say anything like digits or names. Once the recording is over, it gives the same options in terms of being forwarded to a phone number or receiving a text link. For example, “John's Florist” as a provider would have their own toll free number that once a user calls, they go right into the recording, text link etc. without having to speak or say a name or code number.

Another embodiment uses the system as an emergency national notification system in several forms such as a lost pet, or lost Alzheimer's patient. For example with a lost pet, the user would register for free to receive a text link if there is a lost pet in their area which has a code on the system. When someone loses a pet and they have a code for that pet, they go on the system and put in the address for the pet. The system searches a 10 or 20 mile radius of that address for all addresses of people who have registered to receive a text link when a pet is lost in that area. The system pushes a text link to those people along with a general description of the pet and has the link to get to the system webpage for that pet where there are photos, etc. If someone who has received the link sees the pet, they can reply back to the text, which gets passed through the system back to the owner.

In another embodiment, users of the system may register for an emergency national notification system where they would receive text links in the event of a national emergency in their area. They could refresh this text link to check for additional info and/or the system could push them a new text link every time the notification is updated on the recording. The public could also communicate back through that text link to inform the authorities (via the system call centers) of information regarding the disaster, etc. In both this and the pet scenario, people are accessing the info by registering and being pushed a link, which then gives them access to the webpage where they can listen to the recording second. They can also give info back to the system, making a two way communication system.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A system for providing individualized information to a consumer over a network, comprising:
a notification apparatus that identifies a subject associated with individualized information to a consumer, where the notification apparatus also provides a unique identifier associated with the subject of the individualized information;
a system server that stores the individualized information from a provider of the information; and
an internet website that allows the consumer to access the individualized information upon receipt of a unique identifier associated with the subject of the individualized information, wherein the consumer sends the unique identifier to the system server through a mobile telecommunications device.

2. The system of claim 1, where the unique identifier comprises a spoken word that this transmitted through the mobile telecommunications device.

3. The system of claim 1, where the unique identifier comprises a textual word.

4. The system of claim 1, where the access to the internet website is allowed through an internet link in an email that is sent to the consumer in response to receipt of the unique identifier.

5. The system of claim 1, where the access to the internet website is allowed through an internet link in a text message that is sent to the consumer in response to receipt of the unique identifier.

6. The system of claim 1, where the individualized information comprises a notification of an emergency situation and the user is allowed to transmit information back to the system server.

7. The system of claim 1, where the individualized information comprises a notification of lost person or pet and the user is allowed to transmit information back to the system server.

8. The system of claim 1, where the system communicates with the consumer through a loaded system application on the mobile telecommunications device.

9. A system for providing individualized information to a consumer over a network, comprising:
a notification apparatus that identifies a subject associated with individualized information to a consumer, where the notification apparatus determines the consumer's location through a GPS capability on a mobile telecommunications device belonging to the consumer;
where the system sends a message alerting the consumer that presence of the notification apparatus;
a system server that stores the individualized information from a provider of the information; and
an internet website that allows the consumer to access the individualized information upon receipt of a the message.

10. The system of claim 9, where the access to the internet website is allowed through an internet link in an email that is sent to the consumer in response to receipt of the unique identifier.

11. The system of claim 9, where the access to the internet website is allowed through an internet link in a text message that is sent to the consumer in response to receipt of the unique identifier.

12. The system of claim 9, where the system filters messages regarding multiple notification apparatus according to predetermined preferences indicated by the consumer.

13. The system of claim 9, where the consumer may save the messages for later review.

14. The system of claim 9, where the system sends a message to the consumer when the consumer's location is within a pre-determined range of the notification apparatus.

15. The system of claim 14, where the notification apparatus is mobile.

16. A system for providing individualized information to a consumer over a network, comprising:
means for a identifying a subject associated with individualized information to a consumer and providing a unique identifier associated with the subject of the individualized information;
means for storing the individualized information from a provider in an electronically accessible media; and
means for allowing the consumer to access the individualized information upon receipt of a unique identifier through a mobile telecommunications device.
